(19) United States
(12) Patent Application Publication
(10) Pub. No.: US 2025/0281862 A1
(43) Pub. Date: Sep. 11, 2025

(54) SCISSOR MECHANISM CLAMPING ASSEMBLY FOR A FILTER COMPARTMENT

(71) Applicant: DualDraw, LLC, Denver, CO (US)

(72) Inventors: Daniel B. PRATHER, Denver, CO (US); Bevin N. SHARPE, Denver, CO (US)

(21) Appl. No.: 18/597,633

(22) Filed: Mar. 6, 2024

(51) Int. Cl. B01D 46/00; B01D 46/48; B23Q 11/00

(52) U.S. Cl. CPC B01D 46/0005; B01D 46/48; B23Q 11/0046; B01D 2265/024

(57) ABSTRACT

Implementations disclosed herein provide a compact and easy to maintain downdraft table for use in facilities with limited floor space that includes a unique filter compartment and exhaust fan assembly located beneath a perforated work surface. The filter compartment may include at least one rectangular filter insert that is removably held in place using a scissor mechanism clamping assembly. The scissor mechanism clamping assembly allows an operator to easily apply a distributed force on the rectangular filter insert to press the filter insert against a filter seat and lock the filter insert in that position. The scissor mechanism clamping assembly further allows the operator to easily release the distributed force from the rectangular filter insert to unseat the filter insert from the filter seat and remove the filter insert from the filter compartment for cleaning or replacement.

### BACKGROUND

Exposure to poor air in industrial facilities can affect the health and safety of employees. Downdraft tables are used to collect dust, fumes, smoke, and particulates during certain industrial operations and applications. Downdraft tables can provide air filtration and maintain the air quality and control in a work environment.

### SUMMARY

Implementations disclosed herein provide a downdraft table comprising a perforated work surface and a clamping assembly. The clamping assembly includes at least two scissor mechanisms, each mounted on opposing sides of a filter intake. One end of each of the scissor mechanisms mounted to a fixed position within the filter intake. The clamping assembly further includes two translating bars, an opposite end of each of the scissor mechanisms mounted to one of the translating bars. The clamping assembly still further includes an adjustment screw to change the position of folding legs making up each of the scissor mechanisms and thereby change the position of the translating bars. The downdraft table also includes a filter cavity to receive a filter insert to be pressed against a filter seat at a fan plenum by the translating pressure bars. The downdraft table further includes a fan assembly to draw air through the perforated work surface, the clamping assembly, the filter insert, and the fan plenum and exhaust filtered air out of the downdraft table.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations as further illustrated in the accompanying drawings and defined in the appended claims.

### BRIEF DESCRIPTION OF THE DRAWINGS

FIG. 1 illustrates a perspective exterior view of an example downdraft table that incorporates a scissor mechanism clamping assembly according for an associated filter compartment.

FIG. 2 illustrates a sectional diagrammatic interior view of an example downdraft table that incorporates a scissor mechanism clamping assembly for an associated filter compartment.

FIG. 3 illustrates an exploded view of an example filter compartment including a scissor mechanism clamping assembly and an exhaust fan assembly.

FIG. 4 illustrates a perspective view of an example filter compartment including a scissor mechanism clamping assembly.

FIG. 5 illustrates a perspective view of an example scissor mechanism clamping assembly for a filter compartment.

FIG. 6 illustrates a perspective view of an example scissor mechanism for a scissor mechanism clamping assembly.

FIG. 7A illustrates a schematic view of a scissor mechanism clamping assembly for a filter compartment in a retracted orientation.

FIG. 7B illustrates a schematic view of the scissor mechanism clamping assembly of FIG. 7A in an extended orientation.

FIG. 8 illustrates a flowchart of example air filtration operations in an example downdraft table.

### DETAILED DESCRIPTION

The disclosed technology includes a downdraft table for industrial applications that require air filtration. Specifically, the downdraft table may include a compact, easy to maintain downdraft table for use in facilities with limited floor space that includes a unique filter compartment and exhaust fan assembly located beneath the work surface. The filter compartment may include at least one rectangular filter insert that is removably held in place using a scissor mechanism clamping assembly. The scissor mechanism clamping assembly allows an operator to easily apply a distributed force on the rectangular filter insert to press the filter insert against a filter seat and lock the filter insert in that position. The scissor mechanism clamping assembly further allows the operator to easily release the distributed force from the rectangular filter insert to unseat the filter insert from the filter seat and remove the filter insert from the filter compartment. Dirty air and clean air are terms used herein to reference the state of an air flow upstream of the filter insert (i.e., dirty air) and downstream of the filter insert (i.e., clean air). Dirty air and clean air are not used herein to define an actual state of cleanliness of the air, as that may vary widely in application. In various implementations, the downdraft table may also include a spark arrestor for fire protection, one or more removable clean-out trays for particulate collection, and a louvre for one-way airflow, for example. All of the aforementioned components may be located in a main housing of the downdraft table.

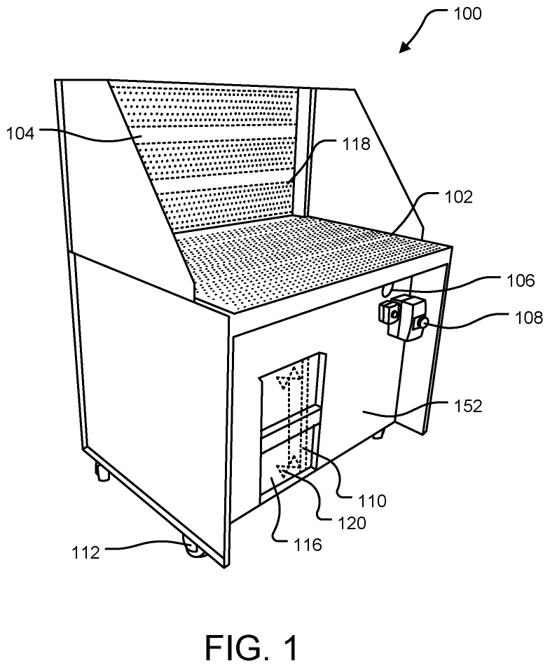

FIG. 1 illustrates a perspective exterior view of an example downdraft table 100. The downdraft table 100 is generally used to collect ambient air in the vicinity of the downdraft table 100 and filter that air before it is discharged back into the atmosphere. This can vastly improve air quality in the vicinity of the downdraft table 100, particularly for operators that are working in the vicinity of the downdraft table 100, including operators that are using the downdraft table 100 as a work surface. In some implementations, the downdraft table 100 includes caster wheels (e.g., wheel 112) that permit operators to move and positioned the downdraft table 100 as desired. In other implementations, the disclosed technology may be included in an air filtration system independent of the downdraft table 100.

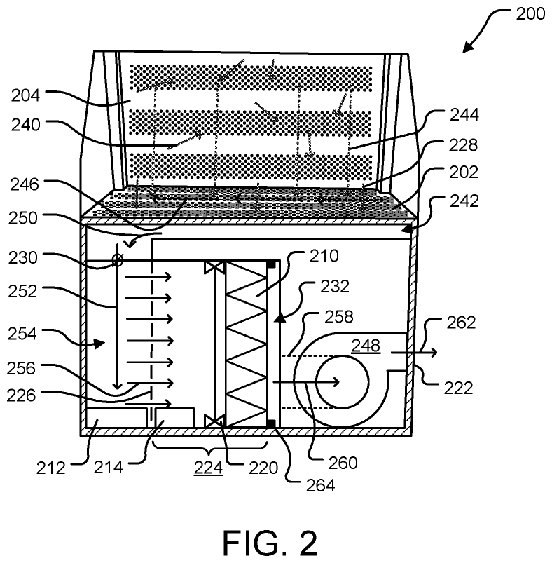

The downdraft table 100 functions by pulling air through a perforated work surface 102 and/or a perforated rear wall 104. Thus, air in FIG. 1 can be pulled downward and/or rearward through the perforated holes into the downdraft table 100 by a fan (not shown, see e.g., fan 248 of FIG. 2), which is located below the perforated work surface 102. The perforations may be consistently spaced (e.g., as illustrated on the perforated work surface 102) or have some variation in pattern (e.g., as illustrated on the perforated rear wall 104). In other implementations, for example in an air filtration system, air can be pulled through an intake, panel, nozzle, or other entry way aside from the perforated work surface 102 and/or the perforated rear wall 104.

As noted above, the downdraft table 100 has one or both of downdraft and backdraft airflow, via the perforations or perforated holes in the perforated work surface 102 and/or the perforated rear wall 104. The perforations can vary in size and shape, for example, the perforations can be ½″× 3/16″ or ½″×⅜″ rectangular holes in 16GA thick material. For further example, the perforations can be 3/16″, ⅜″, or ½″ diameter circular holes in ½″ thick material. In some implementations, the perforations are arranged on multiple grates that make up the perforated work surface 102 and/or the perforated rear wall 104. For example, the perforations may be configured into removable grates, such as removable grate 118 (illustrated by an area of uniformly distributed perforations bounded by parallel broken lines). These grates may be 5″ wide, 1″ thick, and span the length of the work surface (e.g., 36″, 48″, 60″, 72″, etc. long), for example. Other work surface configurations are contemplated. The vacuum of the fan in the downdraft table 100 provides even dispersion of negative air pressure and a resulting inward airflow over the perforated work surface 102 and/or the perforated rear wall 104 of the downdraft table 100.

The downdraft table 100 will have a power supply appropriate for power needs of the downdraft table 100, including but not limited to a motor driving the fan and various sensors and controls for the downdraft table 100. The downdraft table 100 may be configured for single phase (115V/230V) or three phase (208-230V/460V) power, for example. The controls (e.g., an on/off switch 108, a pressure gauge 106, etc.) are located on a front panel 152 of the downdraft table 100. In other implementations, the controls may be located in different areas of the downdraft table 100. The on/off switch 108 for a motor and its associated fan selectively pulls air from the perforated work surface 102 and/or the perforated rear wall 104 down into the downdraft table 100 and out through an exhaust (not shown) in the back of the downdraft table 100. In some implementations, the on/off switch 108 may be a manual toggle switch that acts as motor starter. The controls may be housed in a NEMA 12/4X enclosure and contain thermal protection that protects an operator from electrical issues.

As vacuum builds up in the downdraft table 100, the pressure gauge 106 measures the air pressure and indicates to the operator if and when the vacuum meets a predetermined differential pressure threshold. In some implementations, the predetermined differential pressure threshold can be a static reading. The pressure gauge 106 provides the operator with an indication of the cleanliness of an internal filter insert 110 (depicted in broken lines as it is hidden from view by access door 116), as a dirty filter insert will cause a vacuum pressure to exceed the differential pressure threshold. Through this feedback, the operator will decide based on the indication of the pressure gauge 106 of when to clean or replace the filter insert 110.

As air, including suspended particulates, is pulled from the exterior of the downdraft table 100, it moves downward and towards the left interior side of the downdraft table 100, for example. This example general airflow direction is depicted in FIG. 2. In other implementations, airflow can be moved in other general directions (e.g., right, front, or back). In some implementations, the air moves through a spark arrestor (not shown, see e.g., spark arrestor 226 of FIG. 2) located under the perforated work surface 102 on the left interior side of the downdraft table 100 between the filter insert 110 and the perforated work surface 102. The spark arrestor adds protection against applications that may create sparks or increased risk of a fire such as welding, grinding metal, or plasma cutting. The air moves through the spark arrestor downward in the downdraft table 100, and then moves in a direction toward the center of the downdraft table 100 into a filter compartment (not shown, see e.g., filter compartment 224 of FIG. 2) that houses the filter insert 110.

As the air moves through the filter insert 110, particulates suspended within the air fall out of the airflow via gravity into one or more removable clean-out trays (not shown, see e.g., trays 212, 214 of FIG. 2) or attach to filter media within the filter insert 110 prior to being ingested into the fan and exhausted out of an exhaust port (not shown, see e.g., exhaust port 222 of FIG. 2) located on a side, rear, or bottom panel of the downdraft table 100. In various implementations, the exhaust port may take the form of a perforated area, area of expanded metal, or a vent pipe on any outside-facing panel of the downdraft table 100. In some implementations, particulate is precluded from blow-back towards the operator by a one-way self-closing louvre (not shown, see e.g., louvre 230 of FIG. 2) that allows dirty air to move through the downdraft table 100 in only one direction, thus preventing reverse airflow through the perforated work surface 102 and/or the perforated rear wall 104 and protecting the operator from potential particulate blow-back.

The filter insert 110 in the downdraft table 100 is designed to address applications that produce dust or fumes on a continuous basis. The operator can observe the pressure gauge 106 to help determine the cleanliness of the filter insert 110. The pressure gauge 106 primarily measures the differential pressure, or pressure drop, across the filter insert 110. When the filter insert 110 has met the predetermined differential pressure threshold and needs to be cleaned or replaced, a notification system can send a signal to alert the operator. The threshold can be a specific pressure range indicating sufficient particulates have accumulated on the filter insert 110 to restrict airflow.

The access door 116 depicted on the front panel 152 of the downdraft table 100 provides access to the filter compartment, including the filter insert 110, a scissor mechanism clamping assembly 120 (depicted in broken lines as it is hidden from view by the access door 116) for securing the filter insert 110 within the filter compartment, and the removable clean-out trays. The downdraft table 100 may have different or additional access doors to that depicted in FIG. 1. For example, another door may be located on the non-depicted side of the downdraft table 100 for access to a right-side interior of the downdraft table 100 for maintenance (e.g., access to the motor, fan, etc.).

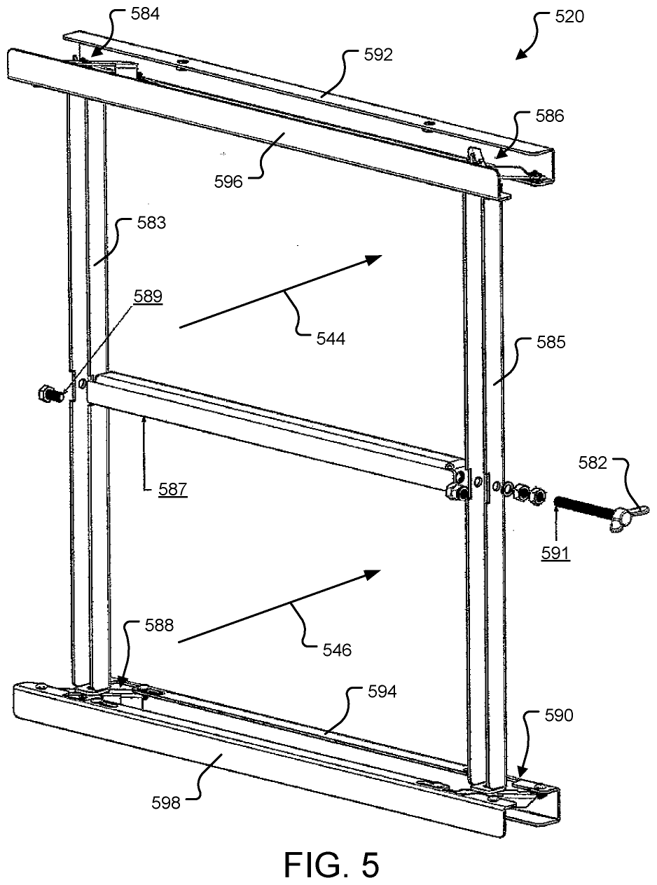

The filter insert 110 is removable and replaceable by hand by manipulating the scissor mechanism clamping assembly 120. More specifically, the filter insert 110 is held in place by the scissor mechanism clamping assembly 120 that applies a uniform force on a perimeter of the filter insert 110 to press and secure the filter insert 110 against a filter seat (not shown, see e.g., filter seat 264 of FIG. 2). The scissor mechanism clamping assembly 120 functions by transforming rotational motion applied to a scissor mechanism handle (not shown, see e.g., scissor mechanism handle 582 of FIG. 5) in a first direction by an operator into a translational motion that seats the filter insert 110 to a fan plenum (not shown, see e.g., fan plenum 232). Rotational motion applied to the scissor mechanism handle in a second opposite direction by the operator drives an opposite translational motion that unseats the filter insert 110 from the fan plenum so that the filter insert 110 may be removed from the filter compartment. In some implementations, a filter gasket may form part of the filter seat and may be compressed between the filter insert 110 and the fan plenum to create the desired seal. As a result, changing filter inserts requires no tools and access to the filter compartment requires only the straightforward removal of the access door 116.

The downdraft table can be a modular design, and tailored to desired applications and sizes, as well as operator requirements. For example, the following downdraft tables with the perforated work surface 102 and the perforated rear wall 104 can be configured for approximately 2000 CFM, 30″D×48″W×58″H; 2500 CFM, 30″D×60″W×58″H; 3000CFM, 30″D×72″W×58″H; 4000 CFM, 30″D×96″W×58″H; 2000 CFM, 30″D×48″W×80″H; 2500 CFM, 30″D×48″W×80″H; 3000 CFM, 30″D×48″W×80″H; or 4000 CFM, 30″D×48″W×80″H. For further example, the following flat top downdraft tables with the perforated work surface 102 only can be configured for approximately 2000 CFM, 30″D×48″W×34″H; 2500 CFM, 30″D×48″W×34″H; 3000 CFM, 30″D×48″W×34″H; or 4000 CFM, 30″D×48″W×34″H. Still further, depth of the downdraft tables may be customized using regular increments, such as 5″ (e.g., 35″, 40″, 45″, 50″, 55″, and 60″). The forgoing are merely examples as other configurations and sizes of the downdraft table 100 are contemplated herein.

FIG. 2 illustrates a sectional diagrammatic interior view of an example downdraft table 200 that incorporates a scissor mechanism clamping assembly 220 for an associated filter compartment 224. Air including suspended particulates, or “dirty air,” is shown moving from a perforated work surface 202 and a perforated rear wall 204 into the interior of the downdraft table 200 to a filter insert 210 using a variety of arrows. Filtered air or “clean air” is shown exiting the filter insert 210, drawn through a fan 248, and exhausted from the downdraft table 200 via an exhaust port 222 using additional arrows. This general movement of air through the downdraft table 200 is described in detail below.

The dirty air is generated in an environment above the perforated work surface 202 (horizontal surface) and in the vicinity of an operator of the downdraft table 200. This air may be harmful to the operator's respiratory health and is thus drawn through holes in the perforated work surface 202, away from the operator, and into the downdraft table 200, as illustrated by downwardly directed solid arrows (e.g., solid downward arrow 228). The air is further drawn through holes in the perforated rear wall 204 (vertical surface), also away from the operator, and into the downdraft table 200, as illustrated by randomly directed solid arrows (e.g., arrow 240).

The dirty air is pulled both downward and rearward through the perforated holes into the downdraft table 200 by the fan 248, which is located below the perforated work surface 202. A static vacuum supplied by the fan 248 on the perforated work surface 202 and the perforated rear wall 204 provides for an even dispersion of airflow over the work surface 202 and the perforated rear wall 204 into the downdraft table 200. In some implementations, the perforated rear wall 204 is omitted from the downdraft table 200 and all the airflow flows through the perforated work surface 202 into the downdraft table 200.

The dirty air is further directed downward into a dirty air intake plenum 242, as illustrated by downwardly directed broken arrows (e.g., downward broken arrow 244), and to the left of within the dirty air intake plenum 242, as illustrated by leftward directed broken arrows (e.g., leftward broken arrow 246). In other implementations, airflow can be moved in another direction (e.g., rightward, frontward, or backward) within the dirty air intake plenum 242. The dirty air moves in the leftward direction within the dirty air intake plenum 242 and then downward into a vertical chute 254, as illustrated by arrows 250, 252. In other implementations, there may be other configurations of compartments, chutes, and pathways.

The dirty air is precluded from reverse airflow through the perforated work surface 202 and/or the perforated rear wall 204 and blow-back towards the operator by a one-way self-closing louvre 230 that allows dirty air to move through the downdraft table 200 in only one direction, thus protecting the operator from potential blow-back of particulate-entrained air. The one-way self-closing louvre 230 is located at the top of the vertical chute 254. In other implementations, the one-way self-closing louvre 230 is omitted if the risk of blow-back is considered low or negligible. The dirty air moves through a spark arrestor 226 located at one side of the vertical chute 254 between the filter insert 210 and the one-way self-closing louvre 230, as illustrated by rightward directed solid arrows (e.g., rightward solid arrow 256). The spark arrestor 226 adds protection against applications that may create sparks or increased risk of a fire such as welding, grinding metal, or plasma cutting.

The bottom of the vertical chute 254 may include removable clean-out trays 212, 214. Particular matter that falls out of the dirty air flow, particularly as it passes through the spark arrestor 226 falls into the removable clean-out trays 212, 214. In other implementations, the downdraft table 100 may have greater or fewer removable clean-out trays, and the removable clean-out trays may be located differently than depicted in FIG. 2. For example, a first tray may be adjacent a bottom of the spark arrestor 226 and a second tray may be adjacent a bottom of the filter insert 210 to collect particulate matter. Removal of the clean-out trays does not require removal of the filter insert 210 or any other disassembly of the unit beyond the removal of an access door (not shown, see e.g., access door 116 of FIG. 1.

The dirty air moves downward through the one-way self-closing louvre 230, rightward through the spark arrestor 226, and then toward a center of the downdraft table 200 into a filter compartment 224 that houses a rectangular filter insert 210. As air moves through the filter insert 210, particulates in the air attach to the filter insert 210. Once the dirty air permeates the filter, “clean” air is drawn into a fan plenum 232 and subsequently fan inlet 258, as illustrated by arrow 260. An exhaust port 222 is located in the side panel of the downdraft table 200, and air exits from the fan 248 out of the downdraft table 200 at the exhaust port 222, as illustrated by arrow 262. In other implementations, the exhaust port 222 may be vented out a different panel of the downdraft table 200 (e.g., a rear or bottom panel).

The configuration of the filter insert 210 in the downdraft table 200 is designed to address applications that produce large amounts of dust or fumes on a continuous basis. An operator can observe a pressure gauge (not shown, see e.g., pressure gauge 106 of FIG. 1) mounted on an exterior panel of the downdraft table 200 facing the operator to help determine the cleanliness of the filter insert 210. The pressure gauge measures the differential pressure across the filter insert 210. A differential pressure greater than a predetermined differential pressure threshold value indicates that air in being blocked by the dirty filter insert 210 and that it should be cleaned or replaced. When the filter insert 210 has met the predetermined differential pressure threshold and needs to be cleaned or replaced, a notification system can send a signal to alert the operator. The threshold can be a specific pressure range indicating sufficient particulates have accumulated on the filter to render the airflow insufficient for efficient operation of the downdraft table 200.

The filter insert 210 is removable and replaceable by hand by manipulating the scissor mechanism clamping assembly 220. More specifically, the filter insert 210 is held in place by the scissor mechanism clamping assembly 220 that applies a uniform force on a perimeter of the filter insert 210 to press and secure the filter insert 210 against filter seat 264. The scissor mechanism clamping assembly 220 functions by transforming rotational motion applied to a scissor mechanism handle (not shown, see e.g., scissor mechanism handle 582 of FIG. 5) in a first direction by an operator into a translational motion that seats the filter insert 210 to the fan plenum 232. Rotational motion applied to the scissor mechanism handle in a second opposite direction by the operator drives an opposite translational motion that unseats the filter insert 210 from the fan plenum 232 so that the filter insert 210 may be removed from the filter compartment 224. In some implementations, a filter gasket may form part of the filter seat 264 and may be compressed between the filter insert 210 and the fan plenum 232 to create the desired seal. As a result, changing filter inserts requires no tools and access to the filter compartment 224 requires only the straightforward removal of the access door.

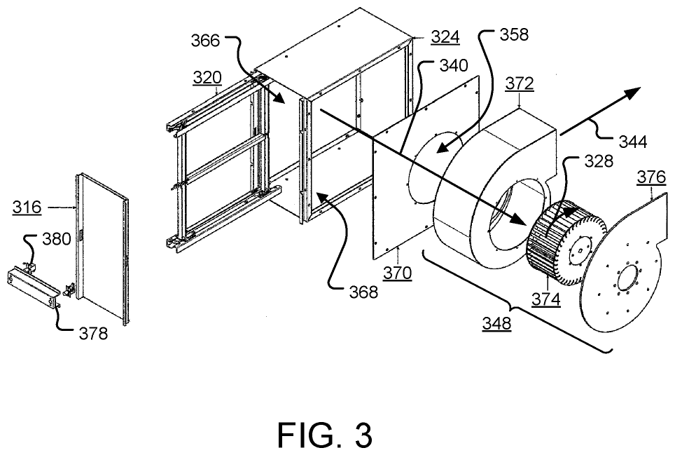

FIG. 3 illustrates an exploded view of an example filter compartment 324 including a scissor mechanism clamping assembly 320 and an exhaust fan assembly 348. In various implementations, the filter compartment 324 is a component of a downdraft table, such as downdraft tables 100 and 200 of FIGS. 1 and 2, respectively. The downdraft table functions to draw air including suspended particulates or “dirty air” from a perforated work surface (not shown, see e.g., perforated work surface 202 of FIG. 2) and/or a perforated rear wall (not shown, see e.g., perforated rear wall 204 of FIG. 2) into an interior of the downdraft table to the filter compartment 324. Filtered air or “clean air” exits the filter compartment 324, is drawn through the fan assembly 348, and exhausted from the downdraft table via an exhaust port (not shown, see e.g., exhaust port 222 of FIG. 2). As such, the filter compartment 324 functions to clean the airflow and the fan assembly 348 functions to draw the airflow through the filter compartment 324. In other implementations, the disclosed technology may be included in an air filtration system independent of a downdraft table.

The filter compartment 324 is generally a rectangular compartment that is sized and shaped to fit within an internal space of the downdraft table between a dirty air intake plenum, a vertical chute, and/or a spark arrestor (not shown, see e.g., dirty air intake plenum 242, vertical chute 254, and spark arrestor 226 of FIG. 2), depending on the specific arrangement of the downdraft table, and the depicted fan assembly 348. The filter compartment 324 encloses the scissor mechanism clamping assembly 320 and a filter insert (not shown, see e.g., filter insert 210 of FIG. 2). An intake 366 of the filter compartment 324 is generally open to the incoming dirty airflow, while an outlet 368 is mostly closed by fan plenum cover 370.

The fan plenum cover 370, when attached to the outlet 368 of the filter compartment 324 forms a fan plenum (not shown, see e.g., fan plenum 232 of FIG. 2) for directing clean air output from the filter insert to a fan inlet 358 to fan housing 372. Squirrel cage impeller 374 rotates (illustrated by arrow 328) to draw the airflow through the filter compartment 324 (illustrated by arrow 340) and output the airflow from the fan assembly 348 (illustrated by arrow 344). An impeller cover 376 encloses the impeller 374 within the fan housing 372. As air moves through the filter insert, particulates in the air attach to the filter insert. Once the dirty air permeates the filter, “clean” air is drawn into the fan plenum and subsequently the fan inlet 358. An exhaust port (not shown, see e.g., exhaust port 222 of FIG. 2 is located in an exterior panel of the downdraft table, and air exits from the fan housing 372 out of the downdraft table at the exhaust port, as illustrated by arrow 340.

An access door 316 provides access to the interior of the filter compartment 324, including the filter insert, the scissor mechanism clamping assembly 320, and removable clean-out trays (not shown, see e.g., trays 212, 214 of FIG. 2, if present). The access door 316 is secured in position with a securing bar 378 and associated fasteners (e.g., fastener 380). Use of the securing bar 378 and associated fasteners is only one example of securing the access door 316. A wide variety of door securing mechanisms are contemplated herein.

The filter insert is removable and replaceable by hand by manipulating the scissor mechanism clamping assembly 320. More specifically, the filter insert is held in place by the scissor mechanism clamping assembly 320 that applies a uniform force on a perimeter of the filter insert to press and secure the filter insert against a filter seat (not shown, see e.g., filter seat 264 of FIG. 2). The scissor mechanism clamping assembly 320 functions by transforming rotational motion applied to a scissor mechanism handle (not shown, see e.g., scissor mechanism handle 582 of FIG. 5) in a first direction by an operator into a translational motion that seats the filter insert to the fan plenum. Rotational motion applied to the scissor mechanism handle in a second opposite direction by the operator drives an opposite translational motion that unseats the filter insert from the fan plenum so that the filter insert may be removed from the filter compartment 324. As a result, changing filter inserts requires no tools and access to the filter compartment 324 requires only the straightforward removal of the access door 316.

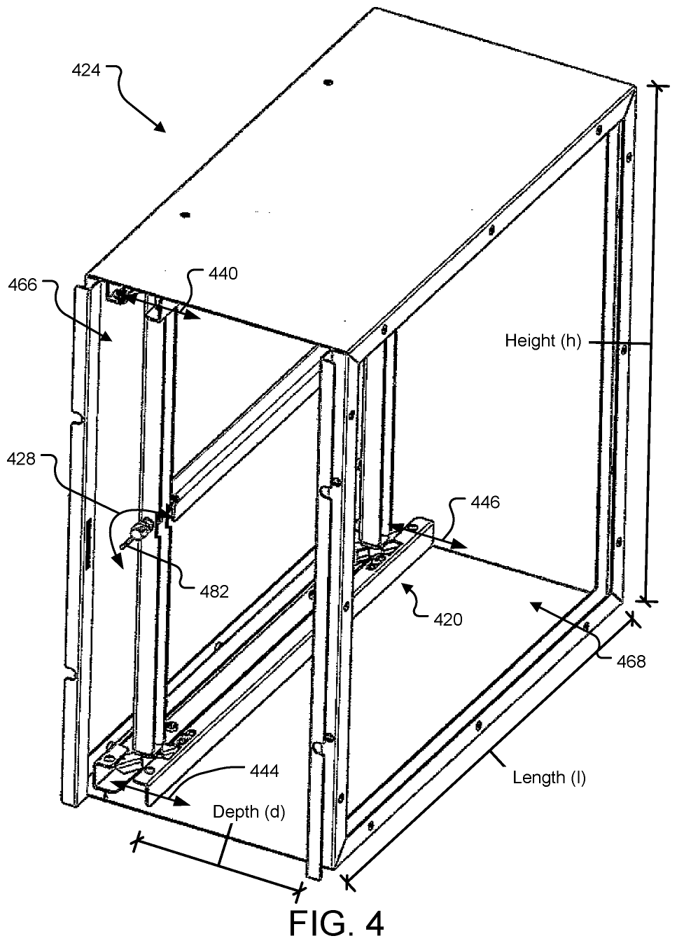

FIG. 4 illustrates a perspective view of an example filter compartment 424 including a scissor mechanism clamping assembly 420. In various implementations, the filter compartment 424 is a component of a downdraft table, such as downdraft tables 100 and 200 of FIGS. 1 and 2, respectively. The downdraft table functions to draw air including suspended particulates or “dirty air” from a perforated work surface (not shown, see e.g., perforated work surface 202 of FIG. 2) and/or a perforated rear wall (not shown, see e.g., perforated rear wall 204 of FIG. 2) into an interior of the downdraft table to the filter compartment 424. Filtered air or “clean air” exits the filter compartment 324, is drawn through a fan assembly (not shown, see e.g., fan assembly 348 of FIG. 3), and exhausted from the downdraft table via an exhaust port (not shown, see e.g., exhaust port 222 of FIG. 2). As such, the filter compartment 424 functions to clean the airflow as it passes through the filter compartment 424. In other implementations, the disclosed technology may be included in an air filtration system independent of a downdraft table.

The filter compartment 424 is a generally rectangular sheet metal box that serves as a housing that is sized and shaped to fit within an internal space of the downdraft table between a dirty side including dirty air intake plenum, a vertical chute, and/or a spark arrestor (not shown, see e.g., dirty air intake plenum 242, vertical chute 254, and spark arrestor 226 of FIG. 2), depending on the specific arrangement of the downdraft table, and a clean side including the fan assembly. The filter compartment 424 encloses the scissor mechanism clamping assembly 420 and a filter insert (not shown, see e.g., filter insert 210 of FIG. 2). An intake 466 of the filter compartment 424 is generally open to the incoming dirty airflow, while an outlet 468 is mostly closed by a fan plenum cover (not shown, see e.g., fan plenum cover 370 of FIG. 3).

The filter insert has a length and height that generally matches a length (l) and height (h) of an interior of the filter compartment 424 so that the filter insert slip fits within the filter compartment 424. The filter insert has a depth that generally matches a depth (d) of the interior of the filter compartment 424 between the scissor mechanism clamping assembly 420 and the outlet 468 of the filter compartment 424 so that the filter insert is easily inserted within or removed from the interior of the filter compartment 424 when the scissor mechanism clamping assembly 420 is retracted. A space within the interior of the filter compartment 424 defined by the foregoing length (l), height (h), and depth (d) may be referred to herein as a filter cavity that receives the filter insert.

The filter insert is removable and replaceable by hand by manipulating the scissor mechanism clamping assembly 420. When the scissor mechanism clamping assembly 420 is extended, the depth (d) of the interior of the filter compartment 424 is reduced and the filter insert is held in place by the scissor mechanism clamping assembly 420 that applies a uniform force on a perimeter of the filter insert to press and secure the filter insert against a filter seat (not shown, see e.g., filter seat 264). The scissor mechanism clamping assembly 420 functions by transforming rotational motion (illustrated by arrow 428) applied to a scissor mechanism handle 482 by an operator into a uniform translational motion (illustrated by arrows 440, 444, 446). Rotation of the scissor mechanism handle 482 in a first direction by the operator extends the scissor mechanism clamping assembly 420 uniformly to seat the filter insert to the fan plenum. Rotation of the scissor mechanism handle 482 in a second opposite direction by the operator drives an opposite translational motion that unseats the filter insert from the fan plenum so that the filter insert may be removed from the filter compartment 424 and a new filter insert may be placed within the filter compartment 424.

FIG. 5 illustrates a perspective view of an example scissor mechanism clamping assembly 520 for a filter compartment (not shown, see e.g., filter compartment 424 of FIG. 4). The filter compartment functions to clean airflow as it passes through the filter compartment. The disclosed technology may be included in a downdraft table, such as downdraft tables 100 and 200 of FIGS. 1 and 2, respectively, or an air filtration system independent of a downdraft table.

The filter compartment encloses the scissor mechanism clamping assembly 520 and a filter insert (not shown, see e.g., filter insert 210 of FIG. 2). An intake of the filter compartment is generally open to an incoming dirty airflow, while an outlet of the filter compartment discharges a clean airflow. Air flows through the filter compartment from the intake to the outlet and transversely through the scissor mechanism clamping assembly 520 within the filter compartment, as generally illustrated by arrows 544, 546.

The scissor mechanism clamping assembly 520 is generally made up of four scissor mechanisms 584, 586, 588, 590, each of which is generally located at one of the four corners of the scissor mechanism clamping assembly 520. When installed within a filter compartment, this similarly locates the four scissor mechanisms 584, 586, 588, 590 near the four corners of the filter compartment to distribute force applied by the scissor mechanisms 584, 586, 588, 590 on a filter insert. The scissor mechanisms 584, 586, 588, 590 each includes a pair of interconnected, folding legs that resemble the shape of a pair of scissors. The scissor mechanisms 584, 586, 588, 590 function as mechanical linkages that are used to create extension or retraction from fixed references.

The scissor mechanism clamping assembly 520 further includes a pair of fixed bars 592, 594 and a pair of translating bars 596, 598. The fixed bars 592, 594 are secured in fixed positions to an interior of the filter compartment. As the scissor mechanism clamping assembly 520 is extended and retracted, the fixed bars 592, 594 remain in their fixed positions. The translating bars 596, 598 move with the scissor mechanisms 584, 586, 588, 590 as the scissor mechanisms 584, 586, 588, 590 are extended and retracted.

A pair of spacer bars 583, 585 connect pivot points of scissor mechanisms 584, 588 and scissor mechanisms 586, 590, respectively. The spacer bars 583, 585 define spacing between the scissor mechanisms 584, 586 and the scissor mechanisms 588, 590 and maintain that spacing as the scissor mechanisms 584, 586, 588, 590 are extended and retracted. The spacer bars 583, 585 further serve selectively move the pivot points of scissor mechanisms 584, 588 and scissor mechanisms 586, 590 closer and further, which drives retraction and extension of the translating bars 596, 598, respectively.

An adjuster bar 587 is positioned between the spacer bars 583, 585 and is bolted to spacer bar 583 with bolt 589 and an associated nut (not shown). The adjuster bar 587 is generally smaller than a space between the spacer bars 583, 585 so that rotation of an adjustment screw 591 connecting the adjuster bar 587 to the spacer bar 585 may selectively draw the adjuster bar 587 toward the spacer bar 585 or push the adjuster bar 587 away from the spacer bar 585, with a variable length of the adjustment screw 591 exposed between the adjuster bar 587 and the spacer bar 585. Rotation of the adjustment screw 591 changes the spacing between the spacer bars 583, 585, and consequently the position of folding legs making up each of the scissor mechanisms 584, 586, 588, 590. This drive changes in extension of the scissor mechanisms 584, 586, 588, 590, further drives a change in position of the translating bars 596, 598.

The filter insert is removable and replaceable from the filter compartment by manipulating the scissor mechanism clamping assembly 520, primarily by rotating a scissor mechanism handle 582 that drives a corresponding rotation of the adjustment screw 591. When the scissor mechanism clamping assembly 520 is in an extended position, the filter insert is held in place by the scissor mechanism clamping assembly 520 applies a uniform force on a perimeter of the filter insert to press and secure the filter insert against a filter seat (not shown, see e.g., filter seat 264 of FIG. 2). As detailed above, the scissor mechanism clamping assembly 520 functions by transforming rotational motion applied to the scissor mechanism handle 582 by an operator into a uniform translational motion of the translating bars 596, 598. Rotation of the scissor mechanism handle 582 in a first direction by the operator extends the translating bars 596, 598 uniformly to seat the filter insert to the fan plenum. Rotation of the scissor mechanism handle 582 in a second opposite direction by the operator drives an opposite translational motion of the translating bars 596, 598 that unseats the filter insert from the fan plenum so that the filter insert may be removed from the filter compartment and a new filter insert may be placed within the filter compartment.

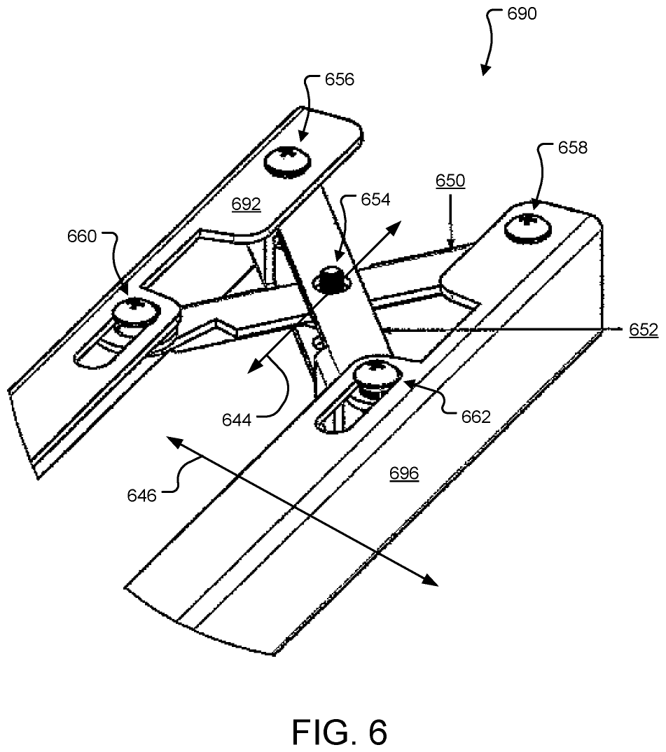

FIG. 6 illustrates a perspective view of an example scissor mechanism 690 for a scissor mechanism clamping assembly (not shown, see e.g., scissor mechanism clamping assembly 520 of FIG. 5). The scissor mechanism clamping assembly is generally made up of at least two scissor mechanisms, such as scissor mechanism 690, each of which are generally located on opposing sides or near opposing corners of the scissor mechanism clamping assembly. The scissor mechanism 690 may be similar to any or all of scissor mechanisms 584, 586, 588, 590 of FIG. 5, for example. In various implementations, the disclosed technology may be included in a filter compartment, such as filter compartment 424; a downdraft table, such as downdraft tables 100 and 200 of FIGS. 1 and 2, respectively; and/or an air filtration system.

The scissor mechanism 690 includes a pair of interconnected, folding legs 650, 652 that resemble the shape of a pair of scissors. The scissor mechanism 690 functions as a mechanical linkage that is used to create extension or retraction from a fixed reference. The scissor mechanism 690 is attached to a fixed bar 692 and a translating bar 696 (both illustrated in part in FIG. 6). The fixed bar 692 is secured in a fixed position to an interior of the filter compartment or other fixed structure. As the scissor mechanism 690 is extended and retracted, the fixed bar 692 remains in its fixed position, while the translating bar 696 moves with the scissor mechanism 690 as the scissor mechanism 690 is extended and retracted.

The folding legs 650, 652 are pivotally connected to one another at center pivot 654. A first end of each of the folding legs 650, 652 is further pivotally connected to one of the fixed bar 692 and the translating bar 696 at fixed pivots 656, 658, respectively. A second opposite end of each of the folding legs 650, 652 is further slidably and pivotally connected to one of the fixed bar 692 and the translating bar 696 at sliding pivots 660, 662, respectively. The center pivot 654 and the fixed pivots 656, 658 are assembled as fasteners, such as a machine screw and nut, extending through aligned holes in the folding legs 650, 652, fixed bar 692, and the translating bar 696. The sliding pivots 660, 662 are also assembled as fasteners, such as a machine screw and nut, extending through aligned holes in the folding legs 650, 652 and aligned slots in the fixed bar 692 and the translating bar 696 to enable the sliding connection in addition to the pivoting connection.

In operation, a separate mechanism (not shown, see e.g., FIG. 5) drives a change in position of the center pivot 654, as illustrated by arrow 644. This movement drives a change the position of the folding legs 650, 652 making up the scissor mechanism 690. This movement further drives a change in extension of the scissor mechanism 690 and a change in position of the translating bar 696, as illustrated by arrow 646.

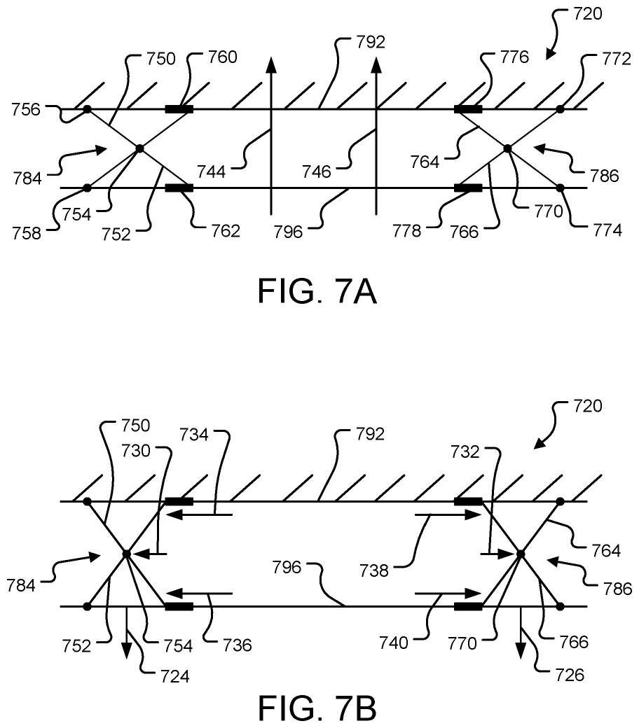

FIG. 7A illustrates a schematic view of a scissor mechanism clamping assembly 720 for a filter compartment (not shown, see e.g., filter compartment 424 of FIG. 4) in a retracted orientation. The filter compartment functions to clean airflow as it passes through the filter compartment. The disclosed technology may be included in a downdraft table, such as downdraft tables 100 and 200 of FIGS. 1 and 2, respectively, or an air filtration system independent of a downdraft table.

The filter compartment encloses the scissor mechanism clamping assembly 720 and a filter insert (not shown, see e.g., filter insert 210 of FIG. 2). An intake of the filter compartment is generally open to an incoming dirty airflow, while an outlet of the filter compartment discharges a clean airflow. Air flows through the filter compartment from the intake to the outlet and transversely through the scissor mechanism clamping assembly 720 within the filter compartment, as generally illustrated by arrows 744, 746.

The scissor mechanism clamping assembly 720 is generally made up of four scissor mechanisms, though only two scissor mechanisms 784, 786 are illustrated in FIGS. 7A and 7B. When installed within a filter compartment, each of the four scissor mechanisms are located near one of four corners of the filter compartment to distribute force applied by the scissor mechanisms on a filter insert. While scissor mechanisms 784, 786 are described in detail below, a similar description could apply to the remaining two scissor mechanisms that are not illustrated in FIGS. 7A and 7B.

The scissor mechanism 784 includes a pair of interconnected, folding legs 750, 752 that resemble the shape of a pair of scissors. The scissor mechanism 786 also includes a similar pair of interconnected, folding legs 764, 766. The scissor mechanisms 784, 786 function as a mechanical linkages that are used to create extension or retraction from a fixed reference. The scissor mechanisms 784, 786 are attached to a fixed bar 792 and a translating bar 796. The fixed bar 792 is secured in a fixed position to an interior of the filter compartment or other fixed structure. As the scissor mechanisms 784, 786 are extended and retracted, the fixed bar 692 remains in its fixed position, while the translating bar 796 moves with the scissor mechanisms 784, 786 as the scissor mechanisms 784, 786 are extended and retracted.

The folding legs 750, 752 are pivotally connected to one another at center pivot 754. A first end of each of the folding legs 750, 752 is further pivotally connected to one of the fixed bar 792 and the translating bar 796 at fixed pivots 756, 758, respectively. A second opposite end of each of the folding legs 750, 752 is further slidably and pivotally connected to one of the fixed bar 792 and the translating bar 796 at sliding pivots 760, 762, respectively. The folding legs 764, 766 are pivotally connected to one another at center pivot 770. A first end of each of the folding legs 764, 766 is further pivotally connected to one of the fixed bar 792 and the translating bar 796 at fixed pivots 772, 774, respectively. A second opposite end of each of the folding legs 764, 766 is further slidably and pivotally connected to one of the fixed bar 792 and the translating bar 796 at sliding pivots 776, 778, respectively.

The center pivots 754, 770 and the fixed pivots 756, 758, 772, 774 are assembled as fasteners, such as a machine screw and nut, extending through aligned holes in the folding legs 750, 752, 764, 766, the fixed bar 692, and the translating bar 696. The sliding pivots 760, 762, 776, 778 are also assembled as fasteners, such as a machine screw and nut, extending through aligned holes in the folding legs 750, 752, 764, 766 and aligned slots in the fixed bar 792 and the translating bar 796 to enable the sliding connection in addition to the pivoting connection.

FIG. 7B illustrates a schematic view of the scissor mechanism clamping assembly 720 of FIG. 7A in an extended orientation. In operation, a separate mechanism (not shown, see e.g., FIG. 5) drives a change in position of the center pivots 754, 770, as illustrated by arrows 730, 732. This movement drives a change the position of the folding legs 750, 752 making up the scissor mechanism 784, as illustrated by arrows 734, 736. This movement further drives a change the position of the folding legs 764, 766 making up the scissor mechanisms 786, as illustrated by arrows 738, 740. This movement further drives a change in extension of the scissor mechanisms 784, 786 and a change in position of the translating bar 796 with reference to the fixed bar 792, as illustrated by arrows 724, 726.

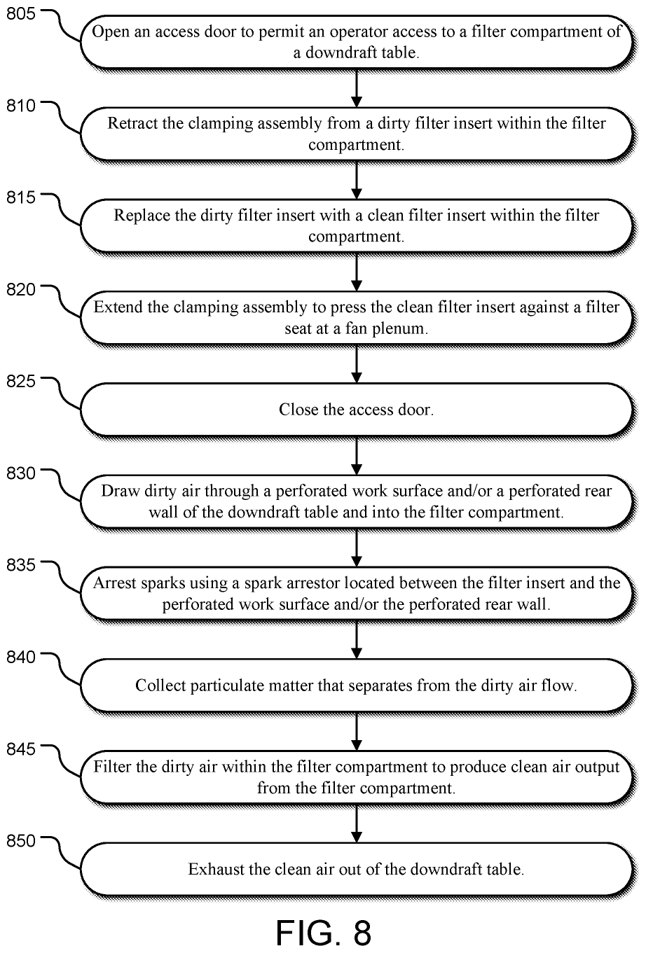

FIG. 8 illustrates example air filtration operations in an example downdraft table. In various implementations, the downdraft table includes an integrated filter compartment. Other implementations omit the downdraft table and integrate the filter compartment within another structure. Operations 805, 810, 815, 820, 825 are directed to using a scissor mechanism clamping assembly for filter replacement within the filter compartment.

Opening operation 805 opens an access door to permit an operator access to the filter compartment. In various implementations, the access door is opened, but remains attached to the downdraft table or access door is completely moved from the downdraft table for the opening operation 805. Retracting operation 810 retracts the clamping assembly from a dirty filter insert within the filter insert. The clamping assembly includes at least two scissor mechanisms, each mounted on opposing sides of an inlet to the filter compartment. One end of each of the scissor mechanisms is mounted to a fixed position within the inlet. The clamping assembly further includes two translating bars. An opposite end of each of the scissor mechanisms is mounted to one of the translating pressure bars. The clamping assembly still further includes an adjustment screw to change the position of folding legs making up each of the scissor mechanisms and thereby change the position of the translating bars. The operator may rotate the adjustment screw in a first direction using a scissor mechanism handle to drive the retraction of the clamping assembly. In implementations where no filter insert is present, the retracting operation 810 provides clearance for insertion of a replacement filter insert in operation 815, discussed below.

Replacing operation 815 replaces the dirty filter insert with a clean filter insert within the filter compartment. Specifically, the operator may physically remove the dirty filter insert from the filter compartment by sliding the dirty filter insert form between the clamping assembly and a fan plenum and out of the open access door. The operator may then physically insert the clean filter insert into the filter compartment by sliding the clean filter insert through the open access door and between the clamping assembly and the fan plenum. An extending operation 820 extends the clamping assembly to press the clean filter insert against a filter seat at the fan plenum. The operator may rotate the adjustment screw in a second direction using the scissor mechanism handle to drive the extension of the clamping assembly. A closing operation 825 replaces the access door, if removed, and closes the access door after the extending operation 820. This secures the filter compartment.

A drawing operation 830 draws dirty air through one or more of a perforated work surface and a perforated rear wall of the downdraft table and into the filter compartment using a fan assembly. The fan assembly provides static vacuum in the downdraft table to provide an even dispersion of airflow through the perforated work surface and/or the perforated rear wall. Thus, the dirty air can be pulled downward, rearward, and/or horizontally through the perforated holes into the downdraft table by the fan assembly, which is located within the downdraft table behind the filter insert. In other implementations, for example in an air filtration system, air can be pulled through an intake, panel, nozzle, or other entry way.

An arresting operation 835 arresting sparks using a spark arrestor located between the filter insert and the perforated work surface and/or the perforated rear wall. The spark arrestor arrests sparks as air is drawn through the downdraft table. The spark arrestor adds protection against applications that may create sparks or increased risk of a fire such as welding, grinding metal, or plasma cutting. Dirty air may move through the spark arrestor downward in the downdraft table, and then move in a direction toward the center of the downdraft table into the filter compartment that houses the filter insert.

A collecting operation 840 collects particulate matter that separates from the dirty air flow prior to filtering operation 845, discussed below, in one or more removable clean-out trays. The operator may periodically remove the clean-out trays to empty the particulate matter. A filtering operation 845 filters the dirty air within the filter compartment to produce clean air output from the filter compartment. As air moves through the filter insert, particulates in the air attach to the filter insert, thereby cleaning the air flow.

An exhausting operation 850 exhausts the clean air out of the downdraft table. In some implementations, an exhaust port is located in the back of the downdraft table, and air exits out a back panel of the downdraft table. In other implementations, the exhaust port may be vented out a different panel of the downdraft table (e.g., a bottom panel). The downdraft table may include a self-closing louvre. The self-closing louvre forces the exhausting operation 850 to flow air in a singular direction, thereby precluding particulate from blow-back through the perforated work surface and/or the perforated rear wall.

The logical operations making up the implementations described herein are referred to variously as a method, operations, steps, objects, or modules. Furthermore, it should be understood that logical operations may be performed in any order, adding or omitting operations as desired, unless explicitly claimed otherwise or a specific order is inherently necessitated by the claim language.

The structure and/or functionality of the downdraft tables, filter compartments, and/or scissor mechanism clamping assemblies may be different that that illustrated in FIGS. 1-8 and described herein. For example, the scissor mechanism clamping assemblies may be integrated in structures beyond downdraft tables or used in combination with other systems for air filtration. Similarly, the arrangement of the components within the downdraft tables and/or filter compartments are provided for purposes of illustration and not of limitation, and some components and/or interconnections may be omitted for purposes of clarity. It will be further appreciated that the downdraft tables, filter compartments, and/or scissor mechanism clamping assemblies may not include all of the components shown in FIGS. 1-8, may include other components that are not explicitly shown in FIGS. 1-8, or may utilize an architecture completely different than that shown in FIGS. 1-8.

The above specification, examples, and data provide a complete description of the structure and use of example implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. The implementations described above, and other implementations are within the scope of the following claims.

what is claimed is:

1. A downdraft table comprising:
a perforated work surface;
a clamping assembly including:
two scissor mechanisms, each mounted on opposing sides of an filter intake, one end of each of the scissor mechanisms mounted to a fixed position within the filter intake;
two translating bars, an opposite end of each of the scissor mechanisms mounted to one of the translating bars;
an adjustment screw to change the position of folding legs making up each of the scissor mechanisms and thereby change the position of the translating bars; and
a filter cavity to receive a filter insert, the filter insert to be pressed against a filter seat at a fan plenum by the translating bars; and
a fan assembly to draw air through the perforated work surface, the clamping assembly, the filter insert, and the fan plenum and exhaust filtered air out of the downdraft table.

2. The downdraft table of claim 1, further comprising:
a perforated rear wall, wherein the fan assembly is further to draw air through the perforated wall.

3. The downdraft table of claim 1, wherein the clamping assembly further includes:
two additional scissor mechanisms, one end of each of the additional scissor mechanisms mounted to a fixed position within the filter intake, wherein:
the scissor mechanisms and the additional scissor mechanisms are mounted near opposing corners of the filter intake;
an opposite end of each of the additional scissor mechanisms are mounted to one of the translating bars; and
the adjustment screw further to change the position of folding legs making up each of the additional scissor mechanisms.

4. The downdraft table of claim 1, further comprising:
an access door to provide an operator access to the filter insert.

5. The downdraft table of claim 1, wherein the filter seat includes a compressible gasket.

6. The downdraft table of claim 1, further comprising:
a removable clean-out tray adjacent to the filter insert for particulate collection.

7. The downdraft table of claim 1, further comprising:
a spark arrestor oriented between the perforated work surface and the filter insert, wherein the fan assembly is further to draw air through the spark arrestor prior to the filter insert.

8. The downdraft table of claim 7, further comprising:
a removable clean-out tray adjacent to the spark arrestor for particulate collection.

9. The downdraft table of claim 1, further comprising:
a one-way, self-closing louvre to prevent reverse airflow through the perforated work surface.

10. A filter compartment comprising:
a housing including an filter intake and a filter outlet;
a clamping assembly including:
two scissor mechanisms, each mounted on opposing sides of the filter intake, one end of each of the scissor mechanisms mounted to a fixed position within the filter intake;
two translating bars, an opposite end of each of the scissor mechanisms mounted to one of the translating bars;
an adjustment screw to change the position of folding legs making up each of the scissor mechanisms and thereby change the position of the translating bars; and
a filter cavity to slidably receive a filter insert, the filter insert to be compressed against a filter seat at the outlet by the translating bars.

11. The filter compartment of claim 10, wherein the clamping assembly further includes:
two additional scissor mechanisms, one end of each of the additional scissor mechanisms mounted to a fixed position within the filter intake, wherein:
the scissor mechanisms and the additional scissor mechanisms are mounted near opposing corners of the filter intake;
an opposite end of each of the additional scissor mechanisms are mounted to one of the translating bars; and
the adjustment screw further to change the position of folding legs making up each of the additional scissor mechanisms.

12. The filter compartment of claim 10, further comprising:
an access door to selectively provide access to the filter cavity to permit replacement of the filter insert.

13. The filter compartment of claim 10, wherein the filter seat includes a compressible gasket.

14. The filter compartment of claim 10, further comprising:
a removable clean-out tray adjacent to the filter insert for particulate collection.

15. A method of using a clamping assembly for filter replacement within a filter compartment comprising:
retracting the clamping assembly from a dirty filter insert, wherein the clamping assembly includes:
two scissor mechanisms, each mounted on opposing sides of an inlet, one end of each of the scissor mechanisms mounted to a fixed position within the inlet;
two translating bars, an opposite end of each of the scissor mechanisms mounted to one of the translating bars; and
an adjustment screw to change the position of folding legs making up each of the scissor mechanisms and thereby change the position of the translating bars, wherein rotation of the adjustment screw in a first direction drives retraction of the clamping assembly;
replacing the dirty filter insert with a clean filter insert within the filter compartment; and
extending the clamping assembly to press the clean filter insert against a filter seat at a fan plenum.

16. The method of claim 15, wherein the filter compartment is within a downdraft table, the method further comprising:
drawing dirty air through one or more of a perforated work surface and a perforated rear wall of the downdraft table and into the filter compartment using a fan assembly;
filtering the dirty air within the filter compartment to produce clean air output from the filter compartment; and
exhausting the clean air out of the downdraft table.

17. The method of claim 15, further comprising:
opening an access door to the filter compartment prior to the retracting operation; and
closing the access door after the extending operation.

18. The method of claim 16, further comprising:
collecting particulate matter that separates from the dirty air prior to the filtering operation in one or more removable clean-out trays.

19. The method of claim 16, further comprising:
precluding particulate from blow-back through the perforated work surface or the perforated rear wall with a one-way self-closing louvre.

20. The method of claim 16, further comprising:
arresting sparks using a spark arrestor located between the filter insert and the perforated work surface or the perforated rear wall.
